(19) United States
(12) Patent Application Publication
(10) Pub. No.: US 2026/0202789 A1
(43) Pub. Date: Jul. 16, 2026

(54) TONER CARTRIDGE

(71) Applicant: GENERAL PLASTIC INDUSTRIAL CO., LTD., Taichung City (TW)

(72) Inventor: Ching-Ho HUANG, Taichung City (TW)

(73) Assignee: GENERAL PLASTIC INDUSTRIAL CO., LTD., Taichung City (TW)

(21) Appl. No.: 19/416,791

(22) Filed: Dec. 11, 2025

(30) Foreign Application Priority Data
Jan. 14, 2025 (TW) 114101550

(51) Int. Cl. G03G 21/16; G03G 15/08

(52) U.S. Cl. CPC G03G 21/1647; G03G 15/0868; G03G 15/0881; G03G 15/0898; G03G 2215/0678; G03G 2221/163; G03G 2221/1815

(57) ABSTRACT

A toner cartridge includes a base mount having a covering portion covering an opening of a barrel body, a sliding seat slidably disposed with the base mount and having a through hole, a linking member, a swingable member pivotally connected with the linking member, and a lifting member. The base mount has a toner outlet, and first, second and third guide portions on two sides of the covering portion. The linking member and lifting member move up and down with the sliding seat. As the sliding seat moves through different positions, the linking member is guided downward by the first guide portion, the swingable member is guided to swing by the second guide portion, and the lifting member is guided downward by the third guide portion, allowing the toner outlet to communicate with the through hole for delivering toner into a toner inlet of an electronic image-forming apparatus.

### BACKGROUND OF THE INVENTION

### 1. Field of the Invention

The present invention relates generally to an electronic image-forming apparatus, and more particularly to a toner cartridge having a toner outlet positioning mechanism.

### 2. Description of the Related Art

General electronic image-forming apparatuses, such as copiers or multifunctional printers, are equipped with toner cartridges. When a toner cartridge is stored or transported, its toner outlet must be sealed. When the toner cartridge is installed in an electronic image-forming apparatus, the toner outlet of the toner cartridge must be aligned and communicated with a toner inlet of the electronic image-forming apparatus so that toner can be delivered into the apparatus. Because the structures of toner inlets vary among different models of electronic image-forming apparatuses, toner cartridges must be specifically designed to match the corresponding apparatus, in order to reliably deliver toner from the toner cartridge into the electronic image-forming apparatus.

### SUMMARY OF THE INVENTION

The present invention has been accomplished in view of the above-noted circumstances. It is an objective of the present invention to provide a toner cartridge that, when assembled into and positioned within an electronic image-forming apparatus, can open its originally sealed toner outlet and allow the toner outlet to communicate with a toner inlet of the electronic image-forming apparatus so that toner can be delivered into the apparatus, while preventing toner leakage during the assembly process.

To attain the above objective, the present invention provides a toner cartridge comprising a barrel body, a base mount, a sliding seat, a linking member, a swingable member, and a lifting member. The barrel body has an opening at one end. The base mount comprises a covering portion covering the opening, a toner outlet disposed on the covering portion, a first guide portion disposed on a first side of the covering portion, a second guide portion disposed on the first side of the covering portion and adjacent to the first guide portion, and a third guide portion disposed on a second side of the covering portion. The sliding seat comprises a main body slidably disposed back and forth with the base mount and a through hole formed in the main body. The sliding seat is movable from a first position toward the barrel body to a second position, then to a third position, and finally to a fourth position. The linking member is movable up and down with the sliding seat and is guided by the first guide portion to move downward when the sliding seat moves from the first position to the second position. The swingable member is pivotally connected with the linking member and is guided by the second guide portion to swing when the sliding seat moves from the second position to the third position. The lifting member is movable up and down with the sliding seat and is guided by the third guide portion to move downward when the sliding seat moves from the second position to the fourth position. When the sliding seat is located at the fourth position, the toner outlet and the through hole communicate with each other. Accordingly, when the toner cartridge of the present invention is assembled into and positioned within an electronic image-forming apparatus, the originally sealed toner outlet can be opened and allowed to communicate with a toner inlet of the apparatus to deliver toner thereto, while preventing toner leakage during assembly.

Further scope of applicability of the present invention will become apparent from the detailed description given hereinafter. However, it should be understood that the detailed description and specific examples, while indicating preferred embodiments of the invention, are given by way of illustration only, since various changes and modifications within the scope of the invention will become apparent to those skilled in the art from this detailed description.

### BRIEF DESCRIPTION OF THE DRAWINGS

The present invention will become more fully understood from the detailed description given herein below and the accompanying drawings which are given by way of illustration only, and thus are not limitative of the present invention, and wherein:

FIG. 1 is a perspective view of a toner cartridge according to a preferred embodiment of the present invention;

FIG. 2 is an exploded view of the toner cartridge according to the preferred embodiment of the present invention;

FIG. 3 is a perspective view of a part of the toner cartridge according to the preferred embodiment of the present invention;

FIGS. 4 and 5 are exploded views of a part of the toner cartridge according to the preferred embodiment of the present invention;

FIGS. 6 to 10 are schematic views illustrating the operation of the toner cartridge with the sliding seat located at the first position according to the preferred embodiment of the present invention;

FIGS. 11 to 13 are schematic views illustrating the operation of the toner cartridge with the sliding seat located at the second position according to the preferred embodiment of the present invention;

FIGS. 14 to 16 are schematic views illustrating the operation of the toner cartridge with the sliding seat located at the third position according to the preferred embodiment of the present invention; and

FIGS. 17 to 20 are schematic views illustrating the operation of the toner cartridge with the sliding seat located at the fourth position according to the preferred embodiment of the present invention.

### DETAILED DESCRIPTION OF THE INVENTION

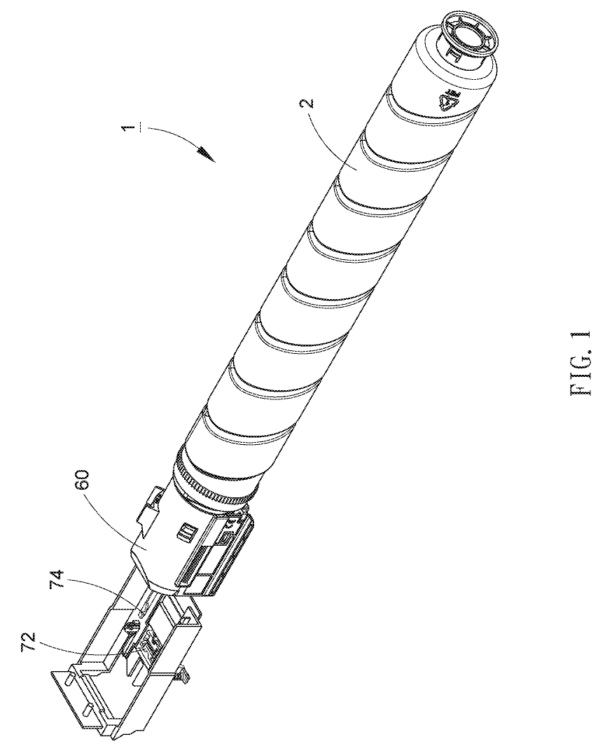

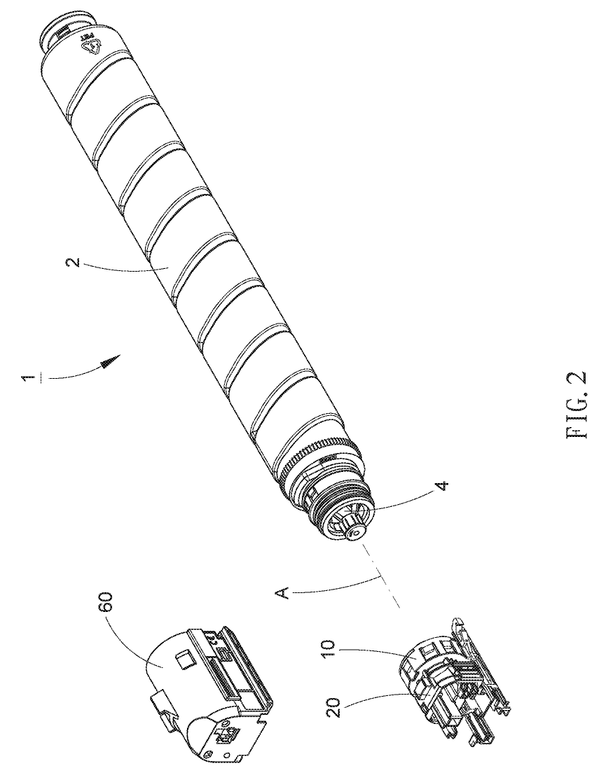

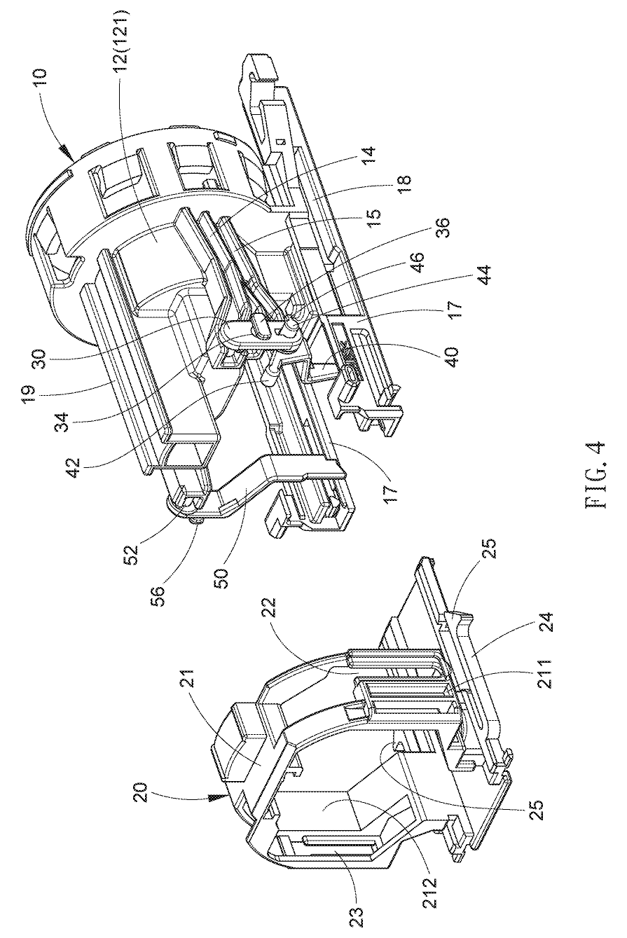

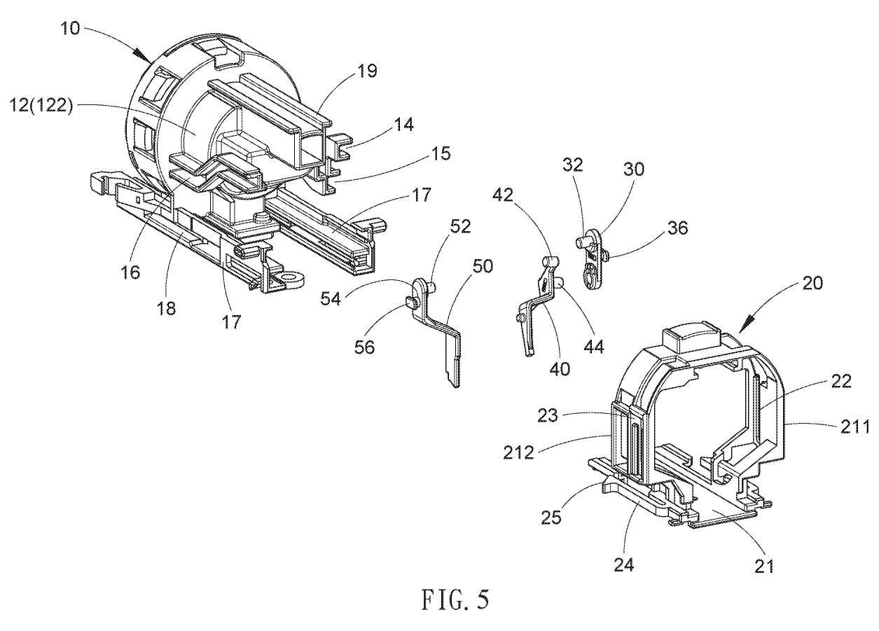

Hereunder one embodiment will be detailedly described with accompanying drawings for illustrating technical features and structure of the present invention. As shown in FIGS. 1-5 and 10, a toner cartridge 1 provided according to a preferred embodiment of the present invention comprises a barrel body 2, a base mount 10, a sliding seat 20, a linking member 30, a swingable member 40, a lifting member 50, and a cover member 60.

The barrel body 2 is cylindrical and configured to contain toner. An opening 4 is formed at one end of the barrel body 2, and the barrel body 2 has an axial direction A.

The base mount 10 includes a covering portion 12 sleeved onto the barrel body 2 to cover the opening 4, a toner outlet 13 disposed on a bottom side of the covering portion 12, a first guide portion 14 disposed on a first side 121 of the covering portion 12, a second guide portion 15 disposed on the first side 121 of the covering portion 12 and adjacent to the first guide portion 14, a third guide portion 16 disposed on a second side 122 of the covering portion 12, two lower sliding portions 17 disposed below the covering portion 12 on left and right sides, two elongated grooves 18 respectively disposed with the two lower sliding portions 17, and an upper sliding portion 19 disposed above the covering portion 12.

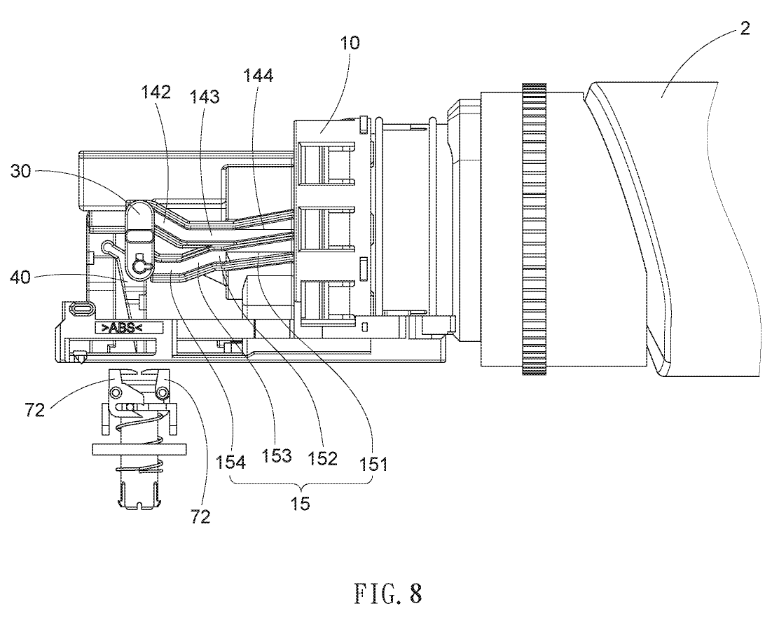

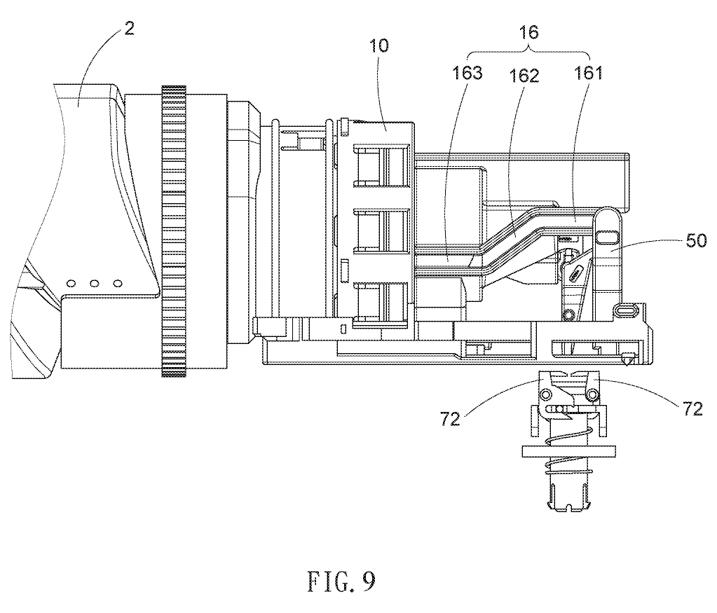

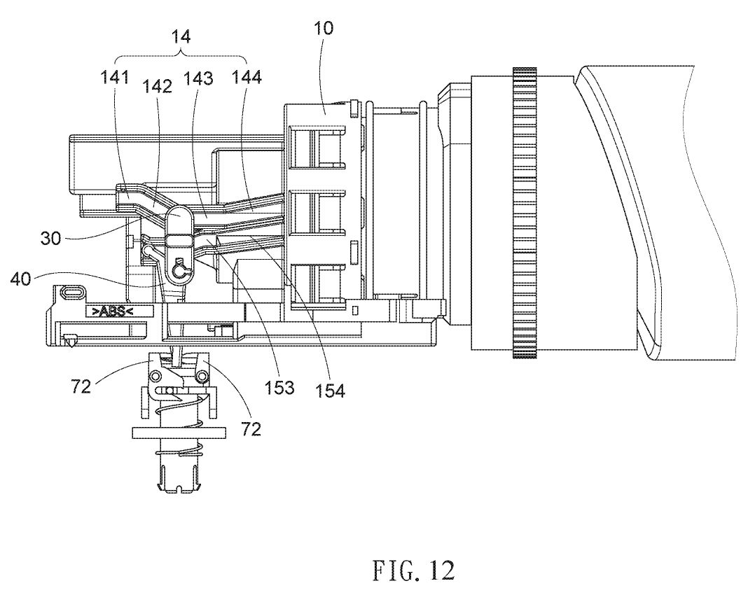

The covering portion 12 is shaped as a circular cap, and the toner outlet 13 communicates with the opening 4. As shown in FIG. 12, the first guide portion 14 is a guide groove that includes, in order toward the barrel body 2, a first initial horizontal section 141, a first downward slanted section 142, a first final horizontal section 143, and a first upward slanted section 144, where the first final horizontal section 143 is located lower than the first initial horizontal section 141. As shown in FIG. 8, the second guide portion 15 is also a guide groove and is located below the first guide portion 14. In order toward the barrel body 2, the second guide portion 15 includes a second initial horizontal section 151 approximately below the first downward slanted section 142, a second initial upward slanted section 152 approximately below the first final horizontal section 143, a second final horizontal section 153 approximately below the first final horizontal section 143, and a second final upward slanted section 154 approximately below the first upward slanted section 144, where the second final horizontal section 153 is located higher than the second initial horizontal section 151. As shown in FIG. 9, the third guide portion 16 is also a guide groove that includes, in order toward the barrel body 2, a third initial horizontal section 161, a third downward slanted section 162, and a third final horizontal section 163, with the third final horizontal section 163 located lower than the third initial horizontal section 161. In this context, “horizontal” refers to directions parallel to the axial direction A of the barrel body 2, rather than absolute horizontal.

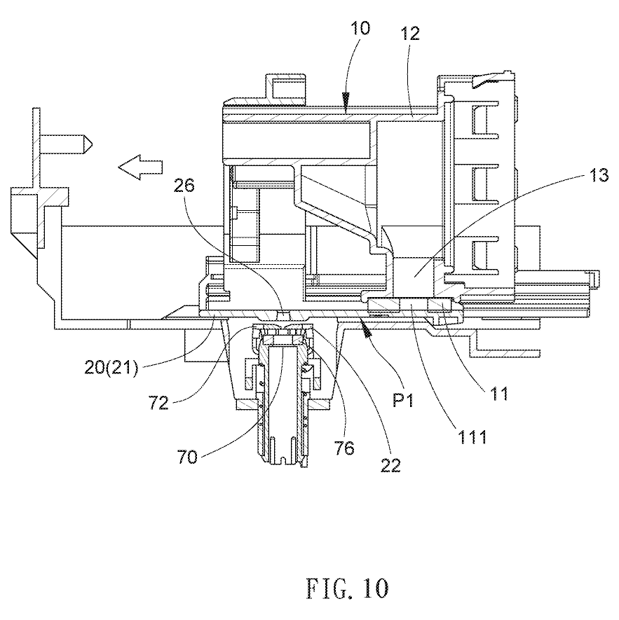

As shown in FIG. 10, a first sealing member 11 is disposed on a bottom side of the base mount 10 at a position corresponding to the toner outlet 13. The first sealing member 11 has a central hole 111 corresponding to the toner outlet 13. The base mount 10 is made of a plastic material, although the material is not limited, and the first sealing member 11 is made of foam sponge. The extending directions of the lower sliding portions 17, the elongated grooves 18, and the upper sliding portion 19 are all parallel to the axial direction A.

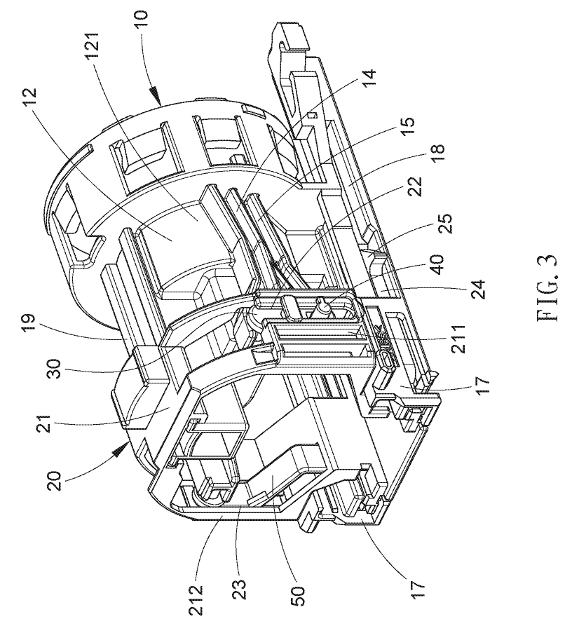

As shown in FIGS. 3-5 and 10, the sliding seat 20 includes a main body 21 slidably disposed back and forth with the base mount 10, a first sliding groove 22 located on a first side 211 of the main body 21 and positioned corresponding to the first guide portion 14 and the second guide portion 15, a second sliding groove 23 located on a second side 212 of the main body 21 and positioned corresponding to the third guide portion 16, two elastic arms 24 extending from the main body 21, and a through hole 26 formed in the main body 21. The distal ends of the two elastic arms 24 extend outward with hooks 25, respectively, and the hooks 25 respectively pass through the two elongated grooves 18 of the base mount 10. The main body 21 is generally annular and is slidably connected with the two lower sliding portions 17 and the upper sliding portion 19, allowing the sliding seat 20 to move along the axial direction A from a first position P1 toward the barrel body 2 to a second position P2, then to a third position P3, and finally to a fourth position P4. The first sliding groove 22 and the second sliding groove 23 extend in an up-and-down direction and are approximately perpendicular to the axial direction A. The sliding seat 20 is made of a plastic material, although the material is not limited.

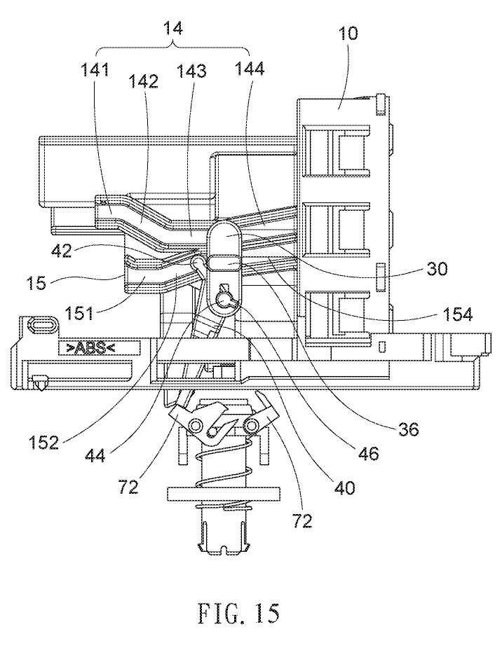

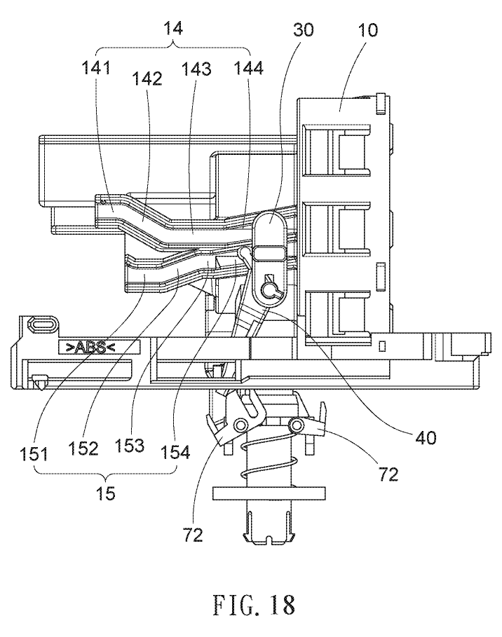

The linking member 30 is disposed movably up and down between the sliding seat 20 and the first guide portion 14. The linking member 30 has a first protruding post 32 extending into the first guide portion 14, a first transverse rod 34 passing through the first sliding groove 22, and a first head portion 36 disposed at an end of the first transverse rod 34 and located outside the first sliding groove 22. The first protruding post 32 is movable along the first guide portion 14, the first transverse rod 34 is movable along the first sliding groove 22, and the first head portion 36 prevents the linking member 30 from laterally disengaging from the first sliding groove 22. Accordingly, as shown in FIG. 12, when the sliding seat 20 moves from the first position P1 to the second position P2, the first protruding post 32 moves from the first initial horizontal section 141 to the first downward slanted section 142, and the linking member 30 is guided by the first guide portion 14 to move downward along the first sliding groove 22. Further, as shown in FIG. 15, when the sliding seat 20 moves from the second position P2 to the third position P3, the first protruding post 32 moves from the first downward slanted section 142 to the first final horizontal section 143, and the linking member 30 does not move. Furthermore, as shown in FIG. 18, when the sliding seat 20 moves from the third position P3 to the fourth position P4, the first protruding post 32 moves from the first final horizontal section 143 to the first upward slanted section 144, and the linking member 30 is guided by the first guide portion 14 to move upward along the first sliding groove 22.

The swingable member 40 is disposed between the sliding seat 20 and the first guide portion 14. The swingable member 40 includes a second protruding post 42 extendable into the second guide portion 15, a second transverse rod 44 pivotally connected to a bottom end of the linking member 30, and a second head portion 46 disposed at an end of the second transverse rod 44 and located outside the first sliding groove 22. The second protruding post 42 is movable along the second guide portion 15, the second transverse rod 44 is movable along the first sliding groove 22, and the second head portion 46 prevents the swingable member 40 from laterally disengaging from the first sliding groove 22. Accordingly, as shown in FIG. 12, when the sliding seat 20 moves from the first position P1 to the second position P2, the second protruding post 42 initially enters the second initial horizontal section 151, and the swingable member 40 does not swing. Further, as shown in FIG. 15, when the sliding seat 20 moves from the second position P2 to the third position P3, the second protruding post 42 moves from the second initial horizontal section 151 to the second initial upward slanted section 152, and the swingable member 40 is guided by the second guide portion 15 to swing about the second transverse rod 44. Furthermore, as shown in FIG. 18, when the sliding seat 20 moves from the third position P3 to the fourth position P4, the second protruding post 42 moves from the second final horizontal section 153 to the second final upward slanted section 154, and the swingable member 40 moves upward together with the linking member 30.

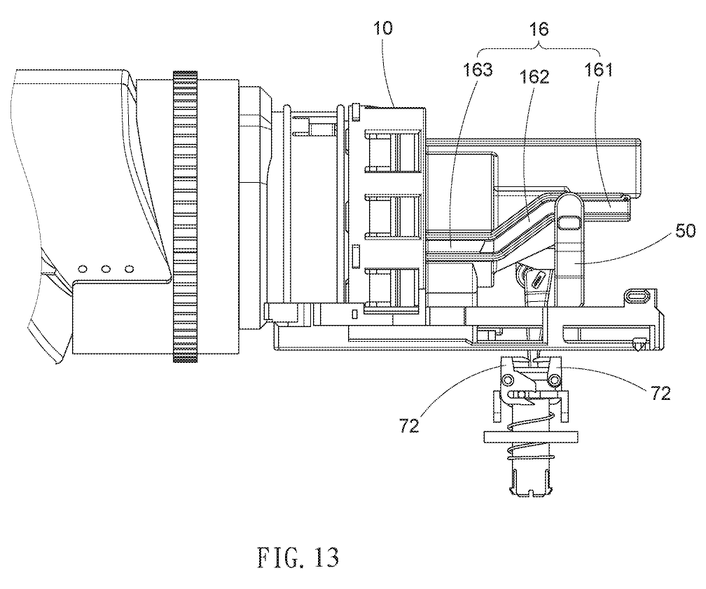

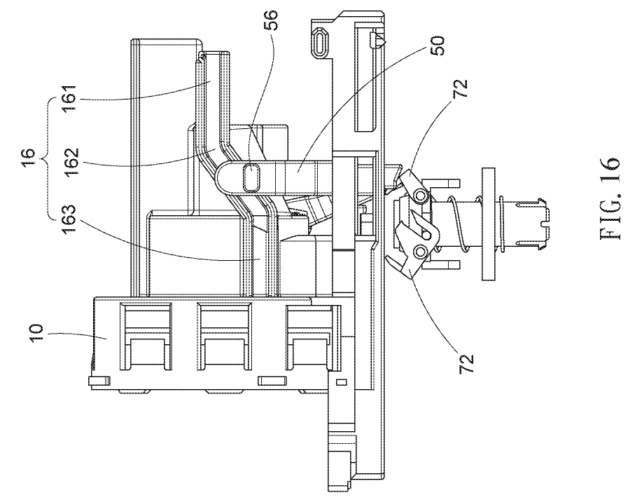

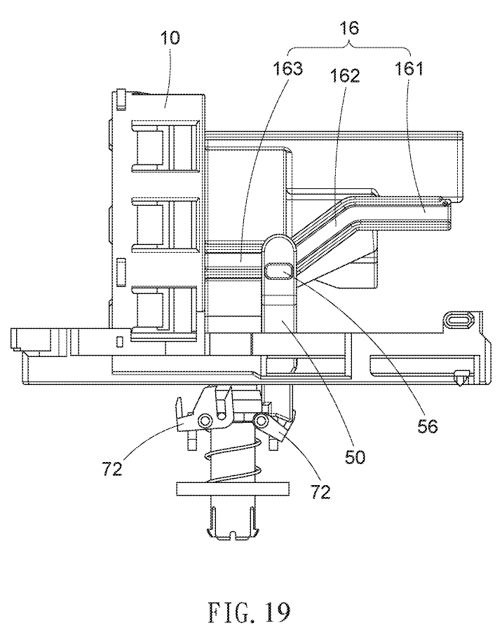

The lifting member 50 is disposed movably up and down between the sliding seat 20 and the third guide portion 16. The lifting member 50 includes a third protruding post 52 extending into the third guide portion 16, a third transverse rod 54 passing through the second sliding groove 23, and a third head portion 56 disposed at an end of the third transverse rod 54 and located outside the second sliding groove 23. The third protruding post 52 is movable along the third guide portion 16, the third transverse rod 54 is movable along the second sliding groove 23, and the third head portion 56 prevents the lifting member 50 from laterally disengaging from the second sliding groove 23. Accordingly, as shown in FIG. 13, when the sliding seat 20 moves from the first position P1 to the second position P2, the third protruding post 52 moves within the third initial horizontal section 161, and the lifting member 50 does not move up or down. Further, as shown in FIG. 16, when the sliding seat 20 moves from the second position P2 to the third position P3, the third protruding post 52 moves from the third initial horizontal section 161 to the third downward slanted section 162, and the lifting member 50 is guided by the third guide portion 16 to move downward along the second sliding groove 23. Furthermore, as shown in FIG. 19, when the sliding seat 20 moves from the third position P3 to the fourth position P4, the third protruding post 52 continues moving within the third downward slanted section 162, and the lifting member 50 is continuously guided by the third guide portion 16 to move downward along the second sliding groove 23.

The cover member 60 is engaged with the base mount 10, thereby protecting other internal components while also reinforcing the structure of the base mount 10, particularly the lower sliding portions 17.

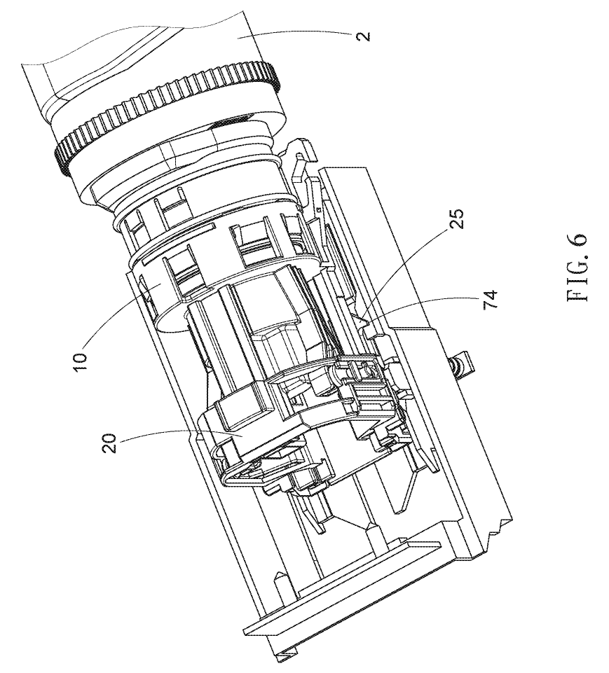

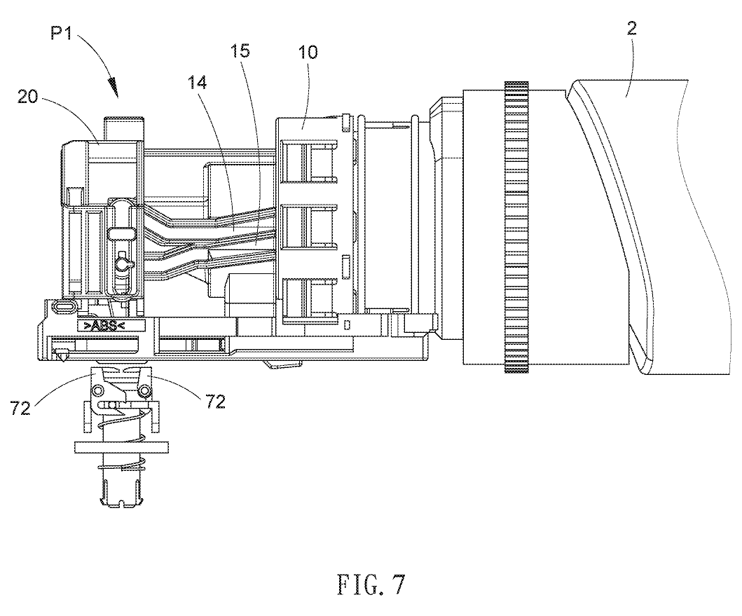

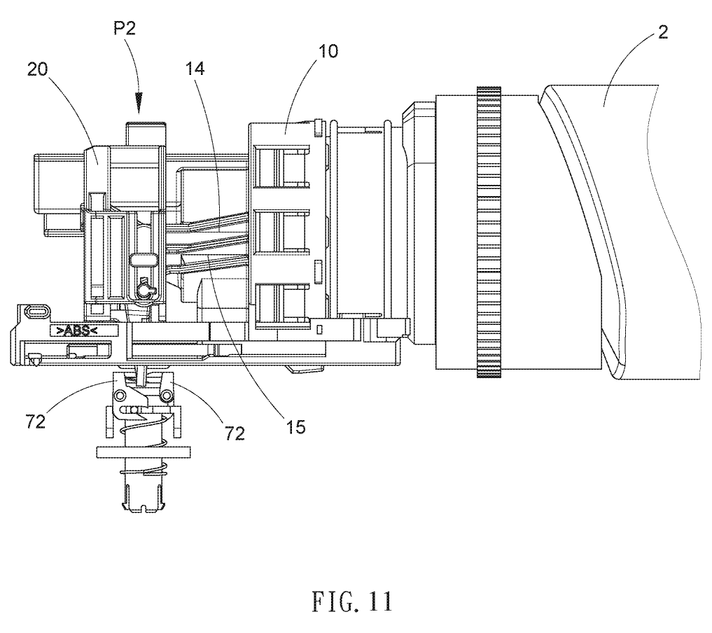

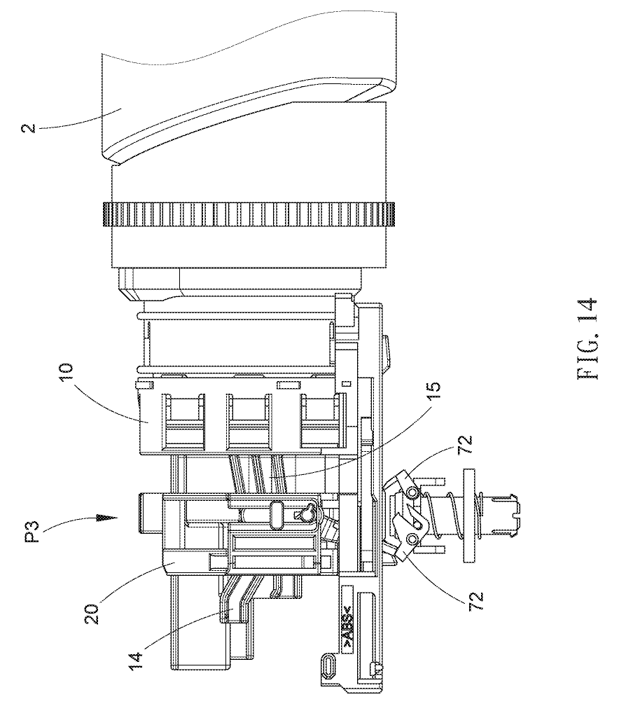

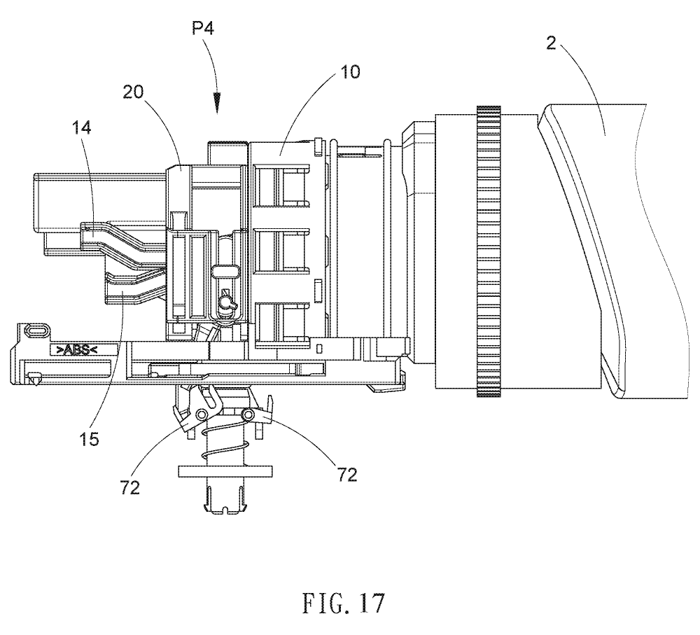

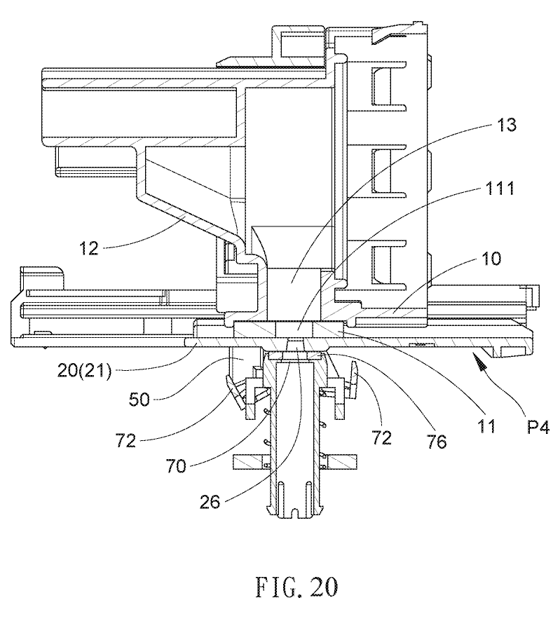

When the toner cartridge 1 is assembled into an electronic image-forming apparatus, the toner outlet 13 must be in alignment and communication with a toner inlet 70 so that toner can be delivered into the apparatus. As shown in FIGS. 7-10, the toner outlet 13 is originally sealed by the main body 21 of the sliding seat 20 located at the first position P1, and two pivotable and linked sealing doors 72 are disposed beside the toner inlet 70 to cover the toner inlet 70. During forward movement of the toner cartridge 1 (i.e., in the direction indicated by the arrow in FIG. 10), the hooks 25 protruding over the elongated grooves 18 first engage recessed portions 74 of the electronic image-forming apparatus, as shown in FIG. 6, preventing the sliding seat 20, the linking member 30, the swingable member 40, and the lifting member 50 from advancing together with the barrel body 2 and the base mount 10. As the base mount 10 continues to advance, the first guide portion 14 drives the linking member 30 and the swingable member 40 to move downward, while the lifting member 50 remains stationary. As shown in FIGS. 11-13, when the sliding seat 20 reaches the second position P2, the swingable member 40 has moved downward to a position between the two sealing doors 72. When the base mount 10 further advances to the third position P3, the second guide portion 15 drives the swingable member 40 to swing and forward push open the front sealing door 72. Because the two sealing doors 72 are linked (not shown in the drawings), the rear sealing door 72 simultaneously swings rearward. At the same time, the third guide portion 16 drives the lifting member 50 downward to abut against the front sealing door 72, as shown in FIGS. 14-16. When the toner cartridge 1 reaches its final positioned state, the sliding seat 20 moves relative to the base mount 10 to the fourth position P4. The third guide portion 16 drives the lifting member 50 to further move downward to press down the front sealing door 72, while the rear sealing door 72 simultaneously swings further rearward, thereby completely opening the toner inlet 70. The first guide portion 14 then drives the linking member 30 to slightly move upward, and the second guide portion 15 drives the swingable member 40 to move upward with the linking member 30, allowing the swingable member 40 to avoid contact with the front sealing door 72, as shown in FIGS. 17-20. At this time, the toner outlet 13, the through hole 26, and the toner inlet 70 are arranged from top to bottom and are aligned to communicate with one another. Together with the first sealing member 11 disposed between the base mount 10 and the sliding seat 20, and the second sealing member 76 disposed above the toner inlet 70 and abutting the bottom side of the sliding seat 20, a sealed passage is formed. This allows toner within the toner cartridge 1 to be smoothly delivered into the electronic image-forming apparatus while preventing toner leakage during assembly, thereby achieving the objectives of the present invention.

Based on the design concept of the present invention, various modifications to the toner cartridge 1 may be made. For example, the first guide portion 14, the second guide portion 15, and the third guide portion 16 do not necessarily need to be guide grooves or recessed portions; they may alternatively be formed as protruding portions, while the linking member 30, the swingable member 40, and the lifting member 50 would then be provided with corresponding recessed portions. The first sliding groove 22 may accommodate other portions of the linking member 30 and the swingable member 40, and the second sliding groove 23 may accommodate other portions of the lifting member 50. Any such variations that can be easily conceived should fall within the scope of the claims of the present invention.

What is claimed is:

1. A toner cartridge, comprising:
a barrel body having an opening at one end thereof;
a base mount comprising a covering portion covering the opening, a toner outlet disposed on the covering portion, a first guide portion disposed on a first side of the covering portion, a second guide portion disposed on the first side of the covering portion and adjacent to the first guide portion, and a third guide portion disposed on a second side of the covering portion;
a sliding seat comprising a main body slidably movable back and forth with the base mount, and a through hole formed in the main body, the sliding seat being movable from a first position toward the barrel body to a second position, then to a third position, and finally to a fourth position;
a linking member movable up and down with the sliding seat, the linking member being guided by the first guide portion to move downward when the sliding seat moves from the first position to the second position;
a swingable member pivotally connected with the linking member, the swingable member being guided by the second guide portion to swing when the sliding seat moves from the second position to the third position; and
a lifting member movable up and down with the sliding seat, the lifting member being guided by the third guide portion to move downward when the sliding seat moves from the second position to the fourth position;
wherein, when the sliding seat is located at the fourth position, the toner outlet and the through hole are in communication with each other.

2. The toner cartridge of claim 1, wherein the sliding seat comprises two elastic arms extending from the main body; each of the two elastic arms extends outward with a hook; the base mount comprises two elongated grooves through which the hooks of the two elastic arms pass, respectively.

3. The toner cartridge of claim 1, wherein the first guide portion is a guide groove.

4. The toner cartridge of claim 3, wherein the linking member has a first protruding post extending into the first guide portion.

5. The toner cartridge of claim 1, wherein the second guide portion is a guide groove.

6. The toner cartridge of claim 5, wherein the swingable member has a second protruding post extending into the second guide portion.

7. The toner cartridge of claim 1, wherein the third guide portion is a guide groove.

8. The toner cartridge of claim 7, wherein the lifting member has a third protruding post extending into the third guide portion.

9. The toner cartridge of claim 1, further comprising a first sealing member disposed with the base mount and abutting against the sliding seat; the first sealing member has a central hole corresponding to the toner outlet.

10. The toner cartridge of claim 1, wherein a first side of the main body of the sliding seat is provided with a first sliding groove into which a portion of the linking member and a portion of the swingable member extend.

11. The toner cartridge of claim 1, wherein a second side of the main body of the sliding seat is provided with a second sliding groove into which a portion of the lifting member extends.

12. The toner cartridge of claim 1, further comprising a cover member engaged with the base mount.

13. The toner cartridge of claim 1, wherein, when the sliding seat moves from the second position to the third position, the linking member does not move.

14. The toner cartridge of claim 1, wherein, when the sliding seat moves from the third position to the fourth position, the linking member is guided by the first guide portion to move upward.

15. The toner cartridge of claim 1, wherein, when the sliding seat moves from the first position to the second position, the swingable member does not swing.

16. The toner cartridge of claim 1, wherein, when the sliding seat moves from the first position to the second position, the lifting member does not move up or down.
